(19) United States
(12) Patent Application Publication
(10) Pub. No.: US 2009/0306244 A1
(43) Pub. Date: Dec. 10, 2009

(54) STERILISATION OF A MEDICAL DEVICE BY IRRADIATION

(76) Inventor: Johannes Wilhelmus Belt, Geleen (NL)

Correspondence Address: NIXON & VANDERHYE, PC, 901 NORTH GLEBE ROAD, 11TH FLOOR, ARLINGTON, VA, 22203, US

(21) Appl. No.: 12/302,612

(22) PCT Filed: May 15, 2007
(86) PCT No.: PCT/EP07/04307

§ 371 Date: Jul. 15, 2009

(30) Foreign Application Priority Data
Jun. 1, 2006 (EP) 06011434.5

(51) Int. Cl. C08K 5/07; B05D 3/06

(52) U.S. Cl. 523/112; 427/2.3; 523/105

(57) ABSTRACT

The present invention relates to the use of at least one compound selected from the group consisting of aliphatic compounds, alicyclic compounds and antioxidants for protecting a wetted hydrophilic coating which is sterilised by irridiation—in particular with γ radiation or E-beam radiation—in the presence of water, from loss of lubricity and/or loss of dry-out time as a result of a reaction between the coating and a radical and/or another reactive moiety formed by irriadiating the water.

The invention relates to the sterilisation of a coated device, in particular a catheter, and to such coated device. The invention further relates to the use of an organic compound capable of elimination or reducing a negative effect of radiation on the coating performance of such coated device.

Many medical devices, such as urinary or cardiovascular catheters need to have a lubricant applied to the outer surface to facilitate insertion into and/or removal from the body and/or to facilitate drainage of fluids from the bodies. Lubricious properties is also desired to minimise soft tissue damage upon insertion or removal. In particular for lubrication purposes, such medical devices may be provided with a hydrophilic outer surface coating which becomes lubricious and attains low friction properties after applying a wetting fluid for a certain time period prior to insertion of the device into the body of a subject (such as a patient). A hydrophilic outer surface coating which is or becomes lubricious after applying an aqueous wetting fluid is hereinafter referred to as a hydrophilic coating. A hydrophilic coating provided with a wetting fluid may hereinafter be referred to as a lubricious coating. Herein lubricious is defined as having a smooth or slippery surface. Examples of wetting fluids are water, water-containing mixtures further comprising one or more organic solvents and/or one or more dissolved components, such as salts. In particular a wetting fluid can be a body fluid or a saline solution having (approximately) physiological osmolarity.

In principle, the medical devices can be wetted (and thereby become lubricious) immediately prior to use. However, from a user's point of view it is desirable to be able to use the device directly after opening of the packaging wherein it is stored. In view of this, medical devices with a hydrophilic coating have been introduced that are sterile-packaged in a package that contains enough wetting fluid to keep the coating wetted (and thus lubricious).

However, suitable sterilisation techniques such as by autoclaving or irradiation have been reported to be detrimental to the water retention capacity and the coefficient of friction when the coatings are stored in water for a long time.

U.S. Pat. No. 6,986,868 discloses a method wherein the medical device having a hydrophilic coating is wetted with an aqueous liquid comprising a hydrophilic polymer. Next the device is sterilised, while being in contact with the liquid. U.S. Pat. No. 6,986,868 refers in general terms to the presence of a plasticizer or of an antioxidant, but it is not suggested that these may have any function in the sterilisation process, let alone to use these in combination to avoid a detrimental effect of the radiation. According to U.S. Pat. No. 6,986,868 a water retention time of more than 3 min can be realised by the method described therein. The examples show water retention times of 1-9 min. for wetted coatings on catheters that have been sterilised by irradiation.

The present inventors have found that upon sterilising a catheter in the presence of a wetting fluid comprising polyvinylpyrrolidone (see Comparative Example, below), using 25 kGy of γ-radiation, both the coating and the wetting fluid were converted in a thick gel, which was difficult to handle. It would be desirable to provide a sterilisation method which would allow the use of a high dosage of radiation, without the risk of converting coating and/or wetting fluid in a thick gel, or at least a method with a reduced risk of such conversion.

For ease of use, it would be desirable if the coating of a medical device (such as a catheter or other tubular medical device) sterilised in the presence of an aqueous wetting fluid would remain lubricious enough to allow convenient insertion into the body, in particular into a body cavity (such as a vessel, in particular a blood vessel, or an urinary tract) for a relatively long time, preferably for at least 10 min. after taking the medical device out of the wetting fluid wherein it has been stored. A prolonged lubricity would also be desirable for lowering the risk of inconveniences due to a reduced lubricity when removing the medical device from the body.

It would further be desirable to provide a sterilisation method and/or a coated device wherein the risk of transforming the coating and/or the wetting liquid into a gel or highly viscous liquid is reduced or even essentially non-existent.

The inventors have realised that when a hydrophilic coating wetted with an aqueous liquid is sterilised by irradiation, highly reactive radicals are formed from water (e.g. .OH, H₂O⁺, superoxide (HO₂/O₂⁻)) and/or other reactive moieties (e.g. H₂O₂). Without being bound be theory, it is contemplated that these reactive moieties cause reactions that are detrimental to the lubricity and in particular to the dry-out time of a coating on an (outer) surface of a medical device. It is thought that such reactions in particular may include excessive cross-linking of the polymer(s) in the coating.

It is an object of the invention to provide method for sterilising a medical device, in particular a catheter or the like, comprising a hydrophilic coating, that can serve as an alternative to known methods/devices. It is further an object to provide such a new device which is sterile or can be sterilised in a method of the invention.

It is in particular an object to provide such method/device overcoming one or more of the problems/disadvantages identified above.

One or more other objects that may be solved in accordance with the present invention will become apparent from the description, below.

The inventors have surprisingly found that it is possible to maintain or improve a property, in particular the dry-out time and/or (initial) lubricity (in terms of smoothness and/or slipperiness), of a hydrophilic coating sterilised by irradiation by carrying out the sterilization in the presence of a specific additive, compared to a similar device not comprising such additive.

Accordingly, the present invention relates to the use of at least one compound selected from the group consisting of aliphatic compounds, alicyclic compounds and antioxidants as a lubricity-stabilising agent in a wetted hydrophilic coating which is sterilised by irradiation with radiation, in particular γ radiation or E-beam radiation.

The term “wetted” is generally known in the art and—in a broad sense—means “containing water”. In particular the term is used herein to describe a coating that contains sufficient water to be lubricious. In terms of the water concentration, usually a wetted coating contains at least 10 wt. % of water, based on the dry weight of the coating, preferably at least 50 wt. %, based on the dry weight of the coating, more preferably at least 100 wt. % based on the dry weight of the coating.

In particular, the invention relates to the use of at least one compound selected from the group consisting of aliphatic compounds, alicyclic compounds and antioxidants for protecting a hydrophilic coating which is sterilised by irradiation—in particular with γ radiation or E-beam radiation—in the presence of water, from loss of lubricity and/or loss of dry-out time as a result of a reaction between the coating and a radical and/or another reactive moiety formed by irradiating the water.

In particular, such use involves the inactivation of a radical or other reactive moiety formed from water as a result of the irradiation.

### LEGENDS TO THE FIGURES

FIG. 1 shows the effect of the presence of vitamin C on the lubricity of a coating on a catheter, after sterilisation. A is without antioxidant, aliphatic compound or alicyclic compound and without having been sterilised; B and C are sterilised catheters of which the coating comprises respectively 0.1 and 2 wt. % antioxidant.

FIG. 2 shows the effect of the presence of PEG 400 or glycerol on the lubricity of a coating on a catheter, after sterilisation. A is without antioxidant, aliphatic compound or alicyclic compound and without having been sterilised; D and E are sterilised catheters of which the coating comprises respectively 5 wt. % PEG respectively glycerol.

FIG. 3 shows the effect of the presence of both vitamin C and glycerol on the lubricity of a coating on a catheter, after sterilisation. A is without antioxidant, aliphatic compound or alicyclic compound and without having been sterilised; F is a sterilised catheter of which the coating comprises 0.1 wt. % vitamin C and 5 wt. % glycerol.

To a stabilising aliphatic compound, alicyclic compound or antioxidant may hereafter be referred to as “lubricity stabilising compound” or “stabilising compound”.

In particular, a stabilising compound is a compound capable of partially or fully stabilising the coating against a detrimental effect of radicals formed from water by the irradiation on the lubricity, such as a decrease of the lubricity and/or the dry-out time.

It is surprising that by adding an aliphatic compound, an alicyclic compound and/or an antioxidant, in particular by adding a aliphatic or alicyclic compound, more in particular a saturated aliphatic or alicyclic compound, the effect of reduced lubricity and/or dry-out time as a result of sterilisation by irradiation is at least partially countered. Without being bound by theory, it is contemplated that in the presence of the stabilising compound, the coating is protected from the attack of radicals and/or other reactive moieties formed from water upon irradiation. It is contemplated that the stabilising compound may react with the reactive moiety or otherwise inactivate it (e.g. trap it) and preventing the reactive moieties from reacting with the coating, such that the coating becomes too much cross-linked. It is further contemplated that the compound may inactivate a moiety that has been formed by reaction with the moiety directly formed from the water.

Within the context of the invention a coating on the (outer) surface of a medical device, such as a catheter, is considered lubricious if it can be inserted into the intended body part without leading to injuries and/or causing unacceptable levels of pain to the subject. In particular, a coating is considered lubricious if it has a friction as measured on a Harland FTS Friction Tester of 20 g or less at a clamp-force of 300 g and a pull speed of 1 cm/s, preferably of 15 g or less, using the settings as identified in the Examples.

Within the context of the invention, the dry-out time is the duration of the coating remaining lubricious after the device has been taken out of the wetting fluid wherein it has been stored/wetted, using the method as described in the Examples.

Within the context of the invention, sterilisation by irradiation involves exposing the item to be sterilised to irradiation, in particular by γ or E-beam irradiation, until the item is sterile. Usually, an irradiation energy of at least 10 kGy is sufficient. Preferably, the irradiation energy is at least 15 kGy, more preferably at least 20 kGy. For practical reasons the irradiation energy is preferably 30 kGy or less.

Preferably, an aliphatic stabilising compound and/or an alicyclic lubricity stabilising compound are used, more preferably such compound is saturated. Particularly good results have been achieved with a saturated aliphatic compound.

In principle any aliphatic stabilising compound and/or alicyclic lubricity stabilising compound may be used, in particular any such compound that is physiologically allowable, preferably non-toxic in the used concentration. Preferably, the aliphatic/alicyclic stabilising compound has a solubility in water (at 25° C.) of at least 0.05 wt. % in order to be able to dissolve enough stabiliser to sufficiently protect the coating during sterilisation. More preferably the solubility is at least 1 wt. %, even more preferably at least 2.5 wt. %, most preferably at least 5 wt. %.

In view of partially or fully avoiding evaporation of the stabilising compound, the stabilising compound preferably has a boiling point of more than 50° C., in particular of at least 80° C., more in particular of at least 100° C. or at least 140° C. and even more in particular of at least 200° C.

Preferably, the stabilising compound is more reactive towards a radical and/or other reactive moiety (an electron, hydrogen peroxide) formed from water due to the irradiation, than the coating.

Preferably, the stabilising compound is able to inactivate a radical which may be formed in a polymer in the coating, thereby preventing the coating from excessive cross-linking.

Regarding the reactivity towards the radicals formed from water and radicals formed in the coating, it is considered advantageous when the stabilising compound comprises one or more bonds that allow transfer of a hydrogen radical from the stabilising compound. In view thereof it is preferred that the aliphatic/alicyclic stabilising compound comprises one or more bonds having a strength of 395 KJ/mol or less, more preferably of 390 KJ/mol or less and most preferably of 385 KJ/mol or less.

A stabilising compound with a relatively low molecular weight is particularly suitable, such as a compound with a molecular weight of less than 1000 g/mol, more in particular of 800 g/mol or less, preferably of 600 gram/mol or less. The use of a low molecular weight compound may have one or more of the following advantages, compared to a compound having a higher molecular weight:

In general, the viscosity of a (liquid comprising a) low molecular weight stabilising compound is lower, which is in particular advantageous in view of handling properties, such as: less stickiness of the coating/wetting fluid, easier immersion in the wetting fluid (when it contains the activating compound).

A wetting fluid comprising such low molecular weight stabilising compound may have a reduced tendency to adhere to the catheter compared to a high molecular weight compounds (in particular polymers). A too high tendency to adhere may result in undesired variations in the effective coating thickness and/or a problem with handling.

A (wetting fluid comprising such) low molecular weight stabilising compound usually has a reduced or no risk of gelling of the wetting fluid and/or the coating, under the sterilisation conditions, compared to a comparable high molecular weight organic compound.

It may further offer the advantage of less contamination of the body wherein the medical device (such as a catheter) may be inserted. Polymeric compounds tend to stick more to body tissue, such as endothelium, and/or are less easily removed by the body than stabilising compounds having a low molecular weight (such as glycerol), and are thus less likely to cause a harmful effect.

Further, the inventors concluded that the effectiveness of a low molecular weight stabilising compound (per weight unit) may be higher than a structurally comparable compound having a high molecular weight. It is contemplated that such compound may have a higher number of labile bonds (bonds that react with the radicals formed from water).

Particularly preferred aliphatic/alicyclic stabilising compounds include alcohols, ethers, aldehydes, ketones, amides, esters, thiols, thioesters, organic acids and combinations thereof. Highly preferred are (saturated) aliphatic compounds selected from the group consisting of (saturated) aliphatic alcohols, ethers, aldehydes, ketones amides, esters, thiols, thioesters, organic acids and combinations thereof.

Preferred alcohols include alkylene glycols, such as diethyleneglycol, triethyleneglycol, tetraethyleneglycol, propyleneglycol, dipropyleneglycol, triprolyeneglycol, (low molecular) ethoxylated or propoxylated alcohols and/or amines like ethanolamine, diethanolamine, triethanolamine, polyethylene glycol (PEG), in particular polyalkylene glycols having a Mw up to about 600 g/mol lower aliphatic alcohols—in particular C1-C8 alcohols, more in particular C2-C4 alcohol, such as glycerol and isopropanol, ethanol, 1-propanol and 1-butanol—and combinations thereof. Good results have further been achieved with a carbohydrate, in particular a monosaccharide, more in particular glucose.

Preferred ethers include polyalkylene glycols, such as PEG.

Suitable aldehydes include C1-C8 aldehydes. Preferred aldehydes include formaldehyde, acetaldehyde and butanol.

Suitable ketones include C3-C8 ketones. Preferred ketones include acetone and methylethylketone.

Suitable organic acids include C1-C8 organic acids. Preferred organic acids include formic acid.

The stabilising compound is generally present in the coating itself and/or in a wetting fluid by which the coating is wetted during sterilisation in an effective concentration to reduce a detrimental effect of the irradiation such as a detrimental effect on the dry-out time. A presence in the wetting fluid may be more effective, because this allows irradiation in the presence of a higher absolute amount of stabilising compound.

In particular, the concentration may be such that the dry-out time (after sterilisation by radiation) is at least 10 min., preferably 15 min. or more, more preferably to 20 min. or more.

When present, the concentration of the one or more aliphatic/alicyclic compounds is usually at least 0.5 wt. %, based on the weight of the water. In particular in case only one or more aliphatic/alicyclic compounds are used for stabilising the coating, the concentration of aliphatic/alicyclic stabilising compound(s) is usually at least 1 wt. %, based on the weight of the water (in the wetted coating and/or in the wetting fluid). The concentration of the aliphatic/alicyclic compound(s) is preferably at least 2.5 wt. %, more preferably at least 5 wt %. For practical reasons, the concentration is usually 25 wt. % or less, based on the weight of the water, preferably 20 wt. % or less, in particular 15 wt. % or less.

It has further been found that the performance (dry-out time, initial slipperiness how friction smoothness) of a coating on a medical device sterilised by irradiation can be improved by using an antioxidant (provided in the coating and/or the wetting fluid), compared to a similar coating wherein no antioxidant is present during sterilisation.

The antioxidant may be used in combination with an alicyclic and/or an aliphatic stabilising compound, or alone.

It has been found that a combination of one or more alicyclic and/or aliphatic stabilising compounds, as defined above, and one or more antioxidants results in a surprising improvement in the lubricity/dry-out time, also when the antioxidant is used at a relatively low concentration.

The use of an antioxidant is in particular considered advantageous in an application wherein the packed medical device is wetted by a vapour hydration system, wherein the medical device is wetted and packed in a package comprising a gas impermeable package containing the device comprising a hydrophilic coating and a wetting fluid which can vaporise in the package such that provides a vapour atmosphere within the package that wets at least a portion of the coating. Such system is e.g. described in WO 2005/014055. In such an application the amount of wetting fluid that is in contact with or in the vicinity of the coating such that the stabilising compound(s) present therein contribute to protection of the coating is limited. Accordingly, an improved efficiency of an antioxidant in combination with an alicyclic and/or an aliphatic stabilising compound is particularly interesting.

It has further been found that especially in an embodiment wherein both an alicyclic and/or aliphatic stabilising compound and an antioxidant are present during sterilisation, a coating is obtained with very few defects or even no defects of significance at all. In particular the combined use has been found advantageous with respect to avoiding bad spots with localised increased friction (stiction or friction peaks) in the coating.

As antioxidant, in principle any antioxidant may be used, in particular any physiologically allowable antioxidant.

An antioxidant is an organic molecule which is capable of preventing or slowing down an oxidation reaction. An antioxidant, as used herein, in general is an organic compound comprising double bonds, in particular a number of conjugated double bonds. Preferably at least one double bound is present in a carbon ring (which may comprise one or more heteroatoms) which contains at least one double bond.

Suitable antioxidants in particular include anti-oxidative vitamins (such as vitamin C and vitamin E) and phenolic antioxidants.

In particular good results have been achieved with a water-soluble antioxidant. An antioxidant is considered water-soluble if its solubility in water at 25° C. is sufficient to dissolve the antioxidant in the intended concentration. In particular an antioxidant is considered water-soluble if its solubility is at least 500 mg/l.

Preferred antioxidants include vitamin C (ascorbic acid), alkyl hydroxybenzyl alcohols (such as 5-di-tert-butyl-4-hydroxybenzyl alcohol), alkyl hydroxybenzoic acids (such as 3,5-di-tert-butyl-4-hydroxybenzoic acid) pyrogallol, alkylated hydroxytoluene (such as butylated hydroxy toluene), 2,6-ditertbutyl-4-ethyl-phenol.

Preferred examples of commercially available phenolics include Irganox 1300™, Irganox 1098™, Irganox 1076™ and combinations thereof.

When present, the concentration of the one or more antioxidants is in general at least 0.005 wt. %, based on the weight of the water. In particular when used alone, the concentration of the antioxidant is usually at least 0.01 wt. %, based upon the weight of the water. Preferably the concentration is at least 0.05 wt. %, more preferably at least 0.1 wt. % based on the water phase.

For practical reasons, such as efficiency, the concentration is usually 1 wt. % or less, based on the weight of the water, preferably 0.5 wt. % or less. In particular in order to reduce or avoid the risk of undesirable colouration (yellowing/browning), the concentration is preferably chosen such that it is low enough to avoid substantial undesirable colouration at the sterilisation conditions. Usually a concentration of 0.2 wt. % or less is considered adequate to avoid undesirable colouration. It is noted that the risk of undesirable colouration is larger with some antioxidants than with others. An advantage of a polyphenolic antioxidant is a low tendency to cause colouration after exposure to a high dose of radiation, compared to e.g. ascorbic acid.

The stabilising compound may in particular be used in a method for preparing a sterile medical device.

In a method of the invention, a sterilised medical device comprising a hydrophilic coating on the outer surface, is prepared by
providing the device with the hydrophilic coating;
wetting the coating of the device with an aqueous wetting fluid; and
sterilising the wetted coated device by exposing it to an effective amount of radiation;
   wherein the wetted coating and/or the wetting fluid comprise at least one aliphatic or alicyclic lubricity stabilising compound (which is capable of protecting against a detrimental effect on the lubricity of a radical formed from water as a result of the radiation) in a total concentration of at least 0.5 wt. %, preferably of at least 1.0 more preferably at least 2.5 wt. %. Usually the concentration of said compound is up to 25 wt. %, preferably up to 20 wt. %, based upon the weight of the water.

The invention further provides a method for preparing a sterilised medical device comprising a hydrophilic coating, the method comprising
providing the device with the hydrophilic coating;
wetting the coating of the device with an aqueous wetting fluid; and
sterilising the wetted coated device by exposing it to an effective amount of radiation;
   wherein the wetted coating and/or the wetting fluid comprise at least one antioxidant in a total concentration of at least 0.005 wt. %, preferably at least 0.01 wt. %, more preferably at least 0.05 wt. %. Usually the concentration of antioxidant is up to 1 wt. %, in particular up to 0.5 wt. %, preferably up to 0.2 wt. %, based upon the weight of the water.

In a further method of the invention a sterilised medical device comprising a hydrophilic coating on the outer surface is prepared by
providing the device with the hydrophilic coating;
wetting the coating of the device with an aqueous wetting fluid; and
sterilising the wetted coated device by exposing it to an effective amount of radiation;
   wherein the wetted coating and/or the wetting fluid comprise at least one antioxidant and at least one compound selected from aliphatic and alicyclic lubricity stabilising compounds.

In a further method of the invention a sterilised medical device comprising a hydrophilic coating on the outer surface is prepared by
providing the device with the hydrophilic coating;
wetting the coating of the device with an aqueous wetting fluid;
sterilising the wetted coated device by exposing it to an effective amount of irradiation;
   wherein the coating and/or the wetting fluid comprises at least one lubricity stabilising compound selected from the group consisting of aliphatic and alicyclic ethers, aliphatic and alicyclic aldehydes, aliphatic and alicyclic ketones, aliphatic and alicyclic amides, aliphatic and alicyclic esters, aliphatic and alicyclic thiols, aliphatic and alicyclic thioesters, aliphatic and alicyclic organic acids and aliphatic and alicyclic alcohols other than glycerol, diethylene glycol and sorbitol.

The invention further relates to a medical device which may be sterilised by a method according to the invention.

In an embodiment, the medical device comprises a hydrophilic coating on an outer surface, wherein the coating comprises a hydrophilic polymer, water, and at least one aliphatic or alicyclic lubricity stabilising compound, wherein the total concentration of the aliphatic or alicyclic lubricity stabilising compound is at least 0.5 wt. %, preferably 1-25 wt. %, more preferably 2.5 to 20 wt. %, based upon the weight of the water.

The invention further provides a medical device, comprising a hydrophilic coating on an outer surface, wherein the coating comprises a hydrophilic polymer, water, and at least one antioxidant in a total concentration of at least 0.005 wt. %, preferably of 0.01 to 1 wt. %, more preferably of 0.05 to 0.2 wt. %, based upon the weight of the water.

A further medical device of the invention comprises a hydrophilic coating on an outer surface, wherein the coating comprises a hydrophilic polymer, and a wetting fluid comprising water and at least one compound selected from lubricity stabilising alicyclic compounds and lubricity stabilising aliphatic compounds, wherein the (total) concentration of the lubricity stabilising compound(s) is at least 1 wt. %, based on the water weight.

Further, the invention provides a medical device comprising a hydrophilic coating on an outer surface, wherein the coating comprises a hydrophilic polymer, at least one aliphatic or alicyclic lubricity stabilising compound, at least one antioxidant and water

In a further embodiment, the medical device comprises a hydrophilic coating on an outer surface, wherein the coating comprises a hydrophilic polymer, and a wetting fluid comprising water and at least one stabilising compound selected from the group consisting of aliphatic and alicyclic ethers, aliphatic and alicyclic aldehydes, aliphatic and alicyclic ketones, aliphatic and alicyclic amides, aliphatic and alicyclic esters, aliphatic and alicyclic thiols, aliphatic and alicyclic thioesters and aliphatic and alicyclic alcohols other than glycerol, diethylene glycol and sorbitol. Examples thereof are given above.

Suitable and preferred choices for the specific compounds, concentrations and other features are generally as identified elsewhere in the present description and/or claims, with the proviso that as specified above in a specific method/device at least one stabilising compound is present other than glycerol, diethylene glycol and sorbitol. Usually, the amount of water is at least 10 wt. % based on the dry weight of the coating, preferably at least 50 wt. %, more preferably at least 100 wt. %.

The invention further relates to a method for manufacturing a device according to the invention wherein the device is coated with a hydrophilic coating composition comprising at least one compound selected from the group consisting of the aliphatic stabilising compounds, alicyclic stabilising compounds and antioxidants.

The coating procedure may further be based on a procedure known in the art.

In principle, the coated device can be any device provided with a hydrophilic coating, in particular any device that should be able to move against body tissue, such as the inner wall of a body vessel or the outer surface of the eye. In particular the device may be selected from the group consisting of medical tubing, guidewires, (needles of) syringes, nutritional delivery systems, canula's, thermometers, condoms, nasogastric tubes, endotracheal tubes and contact lenses. Preferably the device is a catheter, in particular a intraluminal catheter, such as an urinary or cardiovascular catheter. Alternatively the catheter may be a guiding catheter. Suitable devices are e.g. described in U.S. Pat. No. 6,986,868 and in WO 98/19729. The contents of these publication with respect to the type of the catheter and the nature of the coating are incorporated herein by reference.

Thickness of the coating may be chosen within wide-limits. Suitable thickness are known in the art. For instance, in particular for catheters, the thickness may be 0.1 μm, or more, in particular 1 μm or more, more in particular 5 μm or more. For convenient insertion in the body a thickness of about 100 μm or less, in particular of 50 μm or less, more in particular of 35 μm or less generally suffices.

In particular, the coating may comprise at least one polymer selected from the group consisting of poly(lactams), in particular polyvinylpyrrolidones (PVP); polyurethanes; homo- and copolymers of acrylic and methacrylic acid (in acidic form); polyvinyl alcohols; polyvinylethers; maleic anhydride based copolymers; polyesters; vinylamines; polyethyleneimines; polyethyleneoxodes; poly(carboxylic acids); polyamides; polyanhydrides; polyphosphazenes; cellulosics, in particular methyl cellulose, carboxymethyl cellulose, hydroxymethylcellulose, hydroxypropylcellulose and other polysaccharides, in particular chitosans, hyaluronic acids, alginates, gelatins, chitins, heparins, dextrans; chondroitin sulphates; (poly)peptides/proteins, in particular collagens, fibrins, elastins, albumin; polyesters, in particular polylactides, polyglycolides, polycaprolactones and polynucleotides. Of these, PVP is particularly preferred.

Generally such hydrophilic polymer may have a weight average molecular weight (Mw) in the range of about 8 000-5 000 000 g/mol. Preferably the Mw is at least, 20 000, more preferably at least 100 000. Advantageously, the Mw is up to 2000000, in particular up to 1 300 000 g/mol. the Mw is the valued as determined by light scattering optionally in combination with size exclusion chromatography.

In particular for polyvinylpyrrolidone (PVP) and polymers of the same class, a polymer having a molecular weight corresponding to at least K15, more in particular K30, even more in particular K80 is preferred. Particular good results have been achieved with a polymer having a molecular weight corresponding to at least K90. Regarding the upper limit, a K120 or less, in particular a K100 is preferred. The K-value is the value as determinable by the Method W1307, Revision 5/2001 of the Viscotek Y501 automated relative viscometer. This manual may be found at www.ispcorp.com/products/hairscin/index_{—}3.html

The concentration of the polymer in the (dry) coating is usually at least 1 wt. %, in particular at least 2 wt. %, preferably at least 10 wt. %, based upon the total weight of the dry coating. Usually the concentration is up to 90 wt. % although its concentration may be higher. Preferably, the concentration is up to 80 wt. %, in particular up to 70 wt. %, up to 60 wt. % or up to 50 wt. %.

In the coating, the presence of a polyelectrolyte is preferred for its beneficial effect on the dry-out time. The use of a compound capable of forming a radical upon radiation (preferably in combination with an antioxidant) has in particular been found advantageous in improving the lubricousness/dry-out time of a coating comprises a polyelectrolyte, in particular a coating comprising both a polyelectrolyte and a hydrophilic polymer mentioned above.

Herein a polyelectrolyte is defined as a polymer, which may be linear, branched or cross-linked, composed of macromolecules comprising constitutional units, in which between 5 and 100% of the constitutional units contain ionic or ionisable groups, or both. A constitutional unit may be a repeating unit, e.g. a monomer.

The polyelectrolyte preferably has a molecular weight in the range of 1 000 to 5 000 000 g/mol, as determined by light scattering, optionally in combination with size exclusion chromatography.

Examples of ionic or ionisable groups that may be present include primary, secondary and tertiary amine groups, primary, secondary, tertiary and quaternary ammonium groups, phosphonium groups, sulphonium groups, carboxylic acid groups, carboxylate groups, sulphonic acid groups, sulphate groups, sulphinic acid groups, sulphinic groups, phosphinic groups and phosphate groups.

Preferably a polyelectrolyte is selected from the group consisting of (salts of) homopolymers and copolymers of acrylic acid, methacrylic acid, acrylamide, maleic acid, sulfonic acid, quaternary ammonium salts and mixtures and/or derivatives thereof.

If present, the concentration of the polyelectrolyte is usually in the range of 1 to 90 wt. %. Preferably it is at least 5 wt. %, in particular at least 10 wt. %. Preferably the concentration is up to 50 wt. %, more preferably up to 30 wt. %. The weight percentages are based upon the dry weight of the coating.

The polyelectrolyte is preferably present in combination with a hydrophilic polymer that is essentially free of ionic groups (such as PVP or another non-ionic/ionisable hydrophilic polymer mentioned above. Herein the other polymer may serve as a hydrophilic supporting network for the polyelectrolyte. An advantage thereof is an increased stability of the coating. In particular the tendency of the polyelectrolyte to leak out of the coating is thus reduced. Further, a combination of two or more of such polymers is advantageous with respect to both lubricity (in particular smoothness) and dry-out time.

The weight to weight ratio of polyelectrolyte to other hydrophilic polymer is preferably in the range of 1:90 to 9:1, more preferably 1:30 to 1:1, even more preferably 1:10 to 1:5.

The coating may be applied to the medical device in a manner which is known in the art. The components forming the coating (polymers, components to be polymerised, other reagents, such as cross-linking/polymerisation reagents) may be dissolved or dispersed in water or another suitable liquid (such as aqueous solutions, organic solvents (such as alcohols (methanol, ethanol, propanol, butanol), ketones such as acetone, tetrahydrofuran) and mixtures thereof). The solution/dispersion may then suitably be applied to at least part of the outer surface of the device, which surface may comprise a metal, polymer, ceramic, glass and/or composite.

As a coating formulation, a coating composition according to the invention may be used. A coating composition for providing a medical device with a lubricious coating according to the invention comprises a hydrophilic polymer which is curable to provide a lubricious coating, a compound selected from the group consisting of the aliphatic stabilising compounds, alicyclic stabilising compounds and antioxidants and optionally a polyelectrolyte. Optionally an effective amount of a polymerization reagent is present, in particular an effective amount of a (photo)initiator, such as benzophenon. Further one or more other additives may be present such as one or more additives selected from preservatives, pharmaceuticals—such as antimicrobial agents, antithrombogenic agents—and plasticisers

Particularly suitable, respectively preferred components of the composition are those described elsewhere in this document. Suitable amounts can be determined based on the properties of the used materials, in particular the used polymer(s) and on the information provided elsewhere in this document.

The hydrophilic polymer concentration is usually at least 1 wt. % in preferably at least 10 wt. %, more preferably at least 50 wt. %. Usually the concentration is up to 90 wt. %, preferably up to 85 wt. %, more preferably up to 80 wt. %. The weight percentages are based on the dry weight of the composition.

If present, the polyelectrolyte concentration is usually 1-90 wt. %, based on the dry weight of the composition, preferably 5-50 wt. %, more preferably 10-30 wt. %;

If present, the concentration of the antioxidant is usually at least 0.005 wt. % based on the dry weight of the composition, preferably 0.01-1 wt. %, more preferably 0.05-0.5 wt. %

If present, the aliphatic and/or alicyclic stabilising compound concentration is usually at least 0.5 wt. %, preferably 1.0-25 wt. %, more preferably 2.5-20 wt. %.

Suitable concentrations of one or more other ingredients that may be present can be based on suitable concentrations known in the art.

In a particular preferred composition both an antioxidant and at least one of alicyclic and aliphatic stabilising compounds are present. In case an alcohol is present as an aliphatic stabilising compound, preferably at least one alcohol other than ethanol and methanol is present, which are suitable solvents and which may evaporate relatively easily due to their low boiling point.

Particularly good results have been achieved with a coating composition comprising
at least one polyvinylpyrrolidone; and/or
at least one polyelectrolyte selected from the group consisting of (salts of) homopolymers and copolymers of acrylic acid, methacrylic acid, acrylamide, maleic acid, sulfonic acid, quaternary ammonium salts and mixtures and/or derivatives thereof; and/or
at least one aliphatic or alicyclic stabilising compound selected from the group consisting of aliphatic polyols—in particular glycerol—, polyethylene glycol, isopropanol, formic acid and a saccharide, in particular glucose; and/or
at least one water soluble antioxidant selected from vitamin C (ascorbic acid), alkyl hydroxybenzyl alcohols (such as 5-di-tert-butyl-4-hydroxybenzyl alcohol), alkyl hydroxybenzoic acids (such as 3,5-di-tert-butyl-4-hydroxybenzoic acid, 3,3″-ditert-butyl-4-hydroxy-benzylalcohol) pyrogallol, alkylated hydroxytoluene (such as butylated hydroxy toluene) and 2,6-ditertbutyl-4-ethyl-phenol.

The composition may be provided with or without solvent. Preferably, the composition comprises sufficient solvent (preferably water, or a mixture comprising water, ethanol, methanol or a mixture comprising at least two of these) to provide a composition that is ready to use. Usually the amount of solvent is at least 50 wt. %, based on the total weight of the composition, in particular at least 75 wt. %, more in particular at least 90 wt. %

Usually the components in the solution/dispersion are thereafter cured to some extent, to provide the hydrophilic coating on the device. Herein curing is understood to refer to physical and/or chemical hardening or solidifying by any method, in particular by heating, cooling, drying, crystallisation, a chemical reaction (e.g. induced by heat or radiation). In the cured state, all or part of the components in the hydrophilic coating may be crosslinked forming covalent linkages between all or part of the components, ionically bound, bound by dipole-dipole type interaction, by Van der Waals forces, by hydrogen bounds or a combination thereof. Optionally, the coating is chemically bound (covalently/ionically) to the surface of the medical device.

Suitable chemical curing in particular includes a curing making use of radiation (visible light, IR, UV, plasma, γ radiation, optionally in the presence of a photo-initiator or thermal initiator). Examples of suitable initiators are known in the art, e.g. from WO 00/18696.

A suitable example of forming a coating by drying or cooling is shown in WO 03/047637, Example 1. U.S. Pat. No. 6,238,788, Example 1, shows another suitable preparation of a coating.

The aqueous wetting fluid (usually a liquid at 25° C.) may in principle be pure water (in case the stabilising compound and optionally the antioxidant are already incorporated in the coating) or a mixture of water and a polar solvent, such as an alcohol. Usually the water content of the total fluid is at least 80 wt. %, based upon the total fluid.

Preferably, the osmolarity of the fluid is about the same as the physiological osmolarity (the osmolarity of a 0.9 wt. % saline solution). To achieve this, usually up to about 0.9 wt. % NaCl is present.

Advantageously with respect to increasing the dry-out time the stabilising compound is preferably present in the wetting fluid, in particular in a concentration as indicated above.

Advantageously with respect to increasing the dry-out time, an antioxidant is preferably present in the wetting fluid, in particular in a concentration as indicated above.

Advantageously a polyelectrolyte, such as identified above when discussing the coating is preferably present in the wetting fluid. This is advantageous with respect to maintaining lubricious properties, in particular when the coated device is stored in the wetting fluid. If present, the concentration of the polyelectrolyte in the wetting fluid is preferably in the range of 0.1 to 5 wt. %.

The wetting fluid (and/or the coating) may include a surfactant. Hereby a surface property of the coating may be improved. The surfactant may be an ionic (anionic/cationic), non-ionic or amphoteric surfactant. Examples of ionic surfactants include alkyl sulphates (such as sodium dodecylsulphates), sodium cholate, bis(2-ethylhexyl)sulphosuccinate sodium salt, quaternary ammonium compounds, such as cetyltrimethylammonium bromide or chloride, lauryldimethylamine oxide, N-lauroylsarcosine sodium salt and sodium deoxycholate. Examples of non-ionic surfactants include alkylpolyglucosides, branched secondary alcohol ethoxylates, octylphenol ethoxylates. If present, the surfactant concentration is usually 0.001-1 wt. %, preferably 0.05-0.5 wt. % of the liquid phase (the wetting fluid or the liquid in the wetted coating)

If desired, one or more further additives can be included in the wetting fluid, such as one or more additives selected from preservatives, antibiotics and the like. Suitable amounts and examples thereof are known in the art.

The wetting may be achieved simply by contacting the wetting fluid and the coated device, e.g. by dipping the device into the (liquid) wetting fluid or by spraying. The wetting may also be realised by vaporising the liquid and contacting the device with the vaporised liquid.

Conveniently, the device is sterilised while being in a sealed packaging, together with the wetting fluid. Suitable sealed packaging is known in the art, e.g. from U.S. Pat. No. 6,986,868 and the references cited therein.

For instance, the medical device (in particular a catheter) may be packed in an assembly comprising at least one medical device and wetting fluid in a package having a cavity for accommodation of the medical device. Usually the package is made with walls of a gas impermeable material for accommodation of the device with said wetting fluid. Such assembly is e.g. described in WO 98/19729, of which the parts dealing with the description of the assembly, in particular the Figures and the description thereof, are herein incorporated by reference.

Advantageously, the medical device is packaged in a ready-to-use vapour hydrated hydrophilic medical device assembly, comprising: a gas impermeable package containing: a hydrophilic coated medical device, and the wetting fluid, wherein the ready-to-use condition of the medical device is due at least in part to the wetting liquid producing a vapour atmosphere within the gas impermeable package that activates at least a portion of the hydrophilic coated medical device. Such assembly is e.g. described in WO 2005/014055, of which the parts dealing with the description of the assembly, in particular the Figures and the description thereof, are herein incorporated by reference.

The invention is now illustrated by the following examples

### EXAMPLE 1

A catheter was provided with a coating formed of a primer and a topcoat, in a manner as described below.

The composition of the primer was as follows: 4.25 wt. % PTGL1000(T-H)2 oligomer, 0.75 wt. % PVP 1,3 M (Aldrich), 0.2 wt. %, Irgacure 2959 (Aldrich. 98%) and 94.8 wt. % ethanol (Merck, reinst).

PTGL1000(T-H)2 oligomer was synthesised as follows: In a dry inert atmosphere toluene diisocyanate (TDI or T, Aldrich, 95% purity, 87.1 g 0.5 mol), Irganox 1035 (Ciba Specialty Chemicals, 0.58 g, 1 wt % relative to hydroxy ethyl acrylate (HEA or H)) and tin(II) 2-ethyl hexanoate (Sigma, 95% purity, 0.2 g, 0.5 mol) were placed in a 1 litre flask and stirred for 30 minutes. The reaction mixture was cooled to 0° C. using an ice bath. HEA (Aldrich, 96% purity, 58.1 g, 0.5 mol) was added dropwise in 30 min, after which the ice bath was removed and the mixture was allowed to warm up to room temperature. After 3 h the reaction was complete. Poly(2-methyl-1,4-butanediol)-alt-poly(tetramethyleneglycol) (Hodogaya, Mₙ=1000 g/mol, PTGL, 250 g, 0.25 mol) was added drop-wise in 30 min. Subsequently the reaction mixture was heated to 60° C. and stirred for 18 h, upon which the reaction was complete as indicated by GPC (showing complete consumption of HEA), IR (displayed no NCO related bands) and NCO titration (NCO content below 0.02 wt %).

The composition of the topcoat was as follows. 5 wt. % PVP 1,3 M (Aldrich), 1.25 wt. % Polyacrylamide-co-acrylic acid sodium salt (hereafter: PAcA) (supplier: Aldrich), 0.06 wt. % benzophenon (Aldrich, 99%), 46.7 wt. % water and 46.7 wt. % methanol (Merck, pa).

### Coating and Curing Process

Shafts for application of the coating were cut from PVC tubing with a length of 23 cm and were closed on one end by applying heat and pressure. A metal guide wire was inserted into the other end and subsequently attached into the catheter holder of the PCX coater.

Dip length for primer was 17.5 cm and for the top-coat 17 cm. Shafts were dip coated and cured using the Harland PCX coater. Intensity of the lamps was on average 60 mW/cm2 and was measured using a Harland UVR 335 (also known as IL 1400), equipped with an International Light detector SED 005#989. Input optic: W#11521, filter wbs320#27794. The instruction manual of International Light was applied, which is available on the internet: www.intl-light.com. UV dose was approximately 0.9 J/cm2 for the primer and 21.6 J/cm2 for the top coat.

The coated PVC tubing was cut to pieces of approximately 20 cm and subsequently immersed in a PE bag into 10 ml of different wetting liquids, as indicated in the following table:

TABLE 1
composition of wetting liquid (wt. %)

| | | |
|---|---|---|
| | | aliphatic/alicyclic |
| solvent | antioxidant | stabilising compound |

| Catheter # | water | vitamin C | PEG 400 | glycerol |
|---|---|---|---|---|
| A | 100 | — | — | — |
| B | 99.9 | 0.1 | — | — |
| C | 98 | 2 | — | — |
| D | 95 | — | 5 | — |
| E | 95 | — | — | 5 |
| F | 94.9 | 0.1 | — | 5 |

The catheters were sterilised in the wetting fluid by exposing them to 25 kGy of γ-radiation, except for Catheter A which remained unsterilised.

The catheters were tested for lubricity and dry-out time.

The lubricity tests were performed in a Harland FTS5000 Friction Tester (HFT). The protocol was as indicated in the following table:

TABLE 2
HFL settings

| | |
|---|---|
| transport movement (cm) | 10 |
| clamp force (g) | 300 |
| pull speed (cm/s) | 1 |
| acceleration time (sec) | 2 |
| number of rubs | 25 |

Friction tester pads from Harland Medical Systems were used: P/N 102692, FTS5000 Friction Tester Pads, 0.125″0.5″0.125″60 durometer.

Subsequently the desired test description was inserted when “run test” was activated. After inserting the guidewire into the catheter the catheter was attached in the holder. The device was adjusted down to the desired position such that the catheter was soaked in the wetting liquid for 1 min. After zero gauging in water the protocol was activated by pushing “start”. The holder was removed from the force gauge and subsequently the catheter was removed from the holder.

Dry-out time was determined by measuring the friction in gram as a function of time the catheter had been exposed to air on the HFT (see above). Measurements were performed after certain intervals during a period of 25 min after taking the wetted coated catheter out of the wetting liquid. The dry-out time was the point in time wherein the friction reached a value of 20 g or higher. Clamp-force in these experiments was 100 gr.

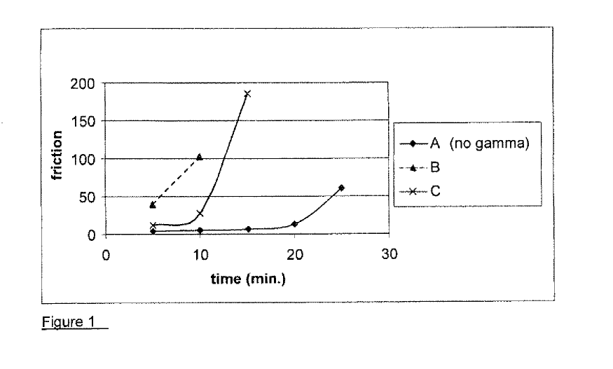

The friction as a function of the drying time (the time that has lapsed after removing the catheter from the wetting liquid) is shown in FIGS. 1-3, for a number of catheters. The result of the friction measurements of the sterilised catheters A (sterilised in water) is not shown. The initial friction (immediately after taking it out of the wetting liquid) already had a value of more than 200 g.

It is shown in the Figures that without sterilisation by irradiation a dry-out time of more than 20 min. is feasible without needing additives. In case only vitamin C is added to the wetting liquid (FIG. 1), some improvement was observed compared to sterilisation in pure water, but even at a 2 wt. % vitamin C concentration a desirable dry-out time was not realised. Moreover, at such a high concentration of vitamin C colouration was observed, after sterilisation.

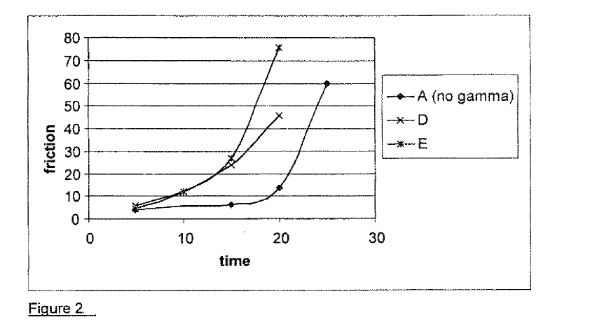

By carrying out the sterilisation in a wetting liquid comprising 5 wt. % glycerol or PEG400, dry-out times of 10 min. or more were observed (see FIG. 2).

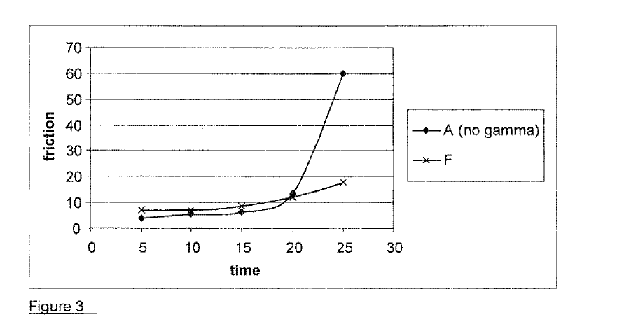

Sterilisation in the presence of a wetting liquid comprising both an antioxidant and the stabilising compound was shown to have the longest dry-out time (see FIG. 3). A dry-out time of more than 20 min was observed. The coating was free from visible defects and the free from stiction/friction peaks.

### COMPARATIVE EXAMPLE

A catheter comprising a coating prepared according to the same procedure as described in Example 1 was immersed in a solution of 5 wt. % PVP K15 (GAF Corporation, Mw. approx. 10 000 g/mol) in water and sterilised under the same conditions as described in Example 1. It was found that both the coating and the wetting fluid were converted in a thick gel. This resulted in handling difficulties.

### EXAMPLE 2

Example 1E was repeated, but now with 10 wt % glycerol instead of 5 wt %. Table 3 shows the friction as a function of time (exposed to air).

TABLE 3

| Time (min) | Friction (gr) |
|---|---|
| 5 | 4.5 |
| 10 | 5.6 |
| 15 | 8.1 |
| 20 | 13.6 |

### EXAMPLE 3

With a new catheter, Example 1D was repeated but with 5 wt. % isopropanol instead of PEG 400. The coating remained lubricious for at least 15 min (Friction after 15 min.: 12 gr, after 20 min: 71.8 gr)

### EXAMPLE 4

With a new catheter, Example 1D was repeated but with formic acid instead of PEG 400. As shown in Table 4, the coating remained lubricious for at least 10 min.

TABLE 4

| Time (min) | Friction (gr) |
|---|---|
| 5 | 5.4 |
| 10 | 12.3 |
| 15 | 27.6 |

### EXAMPLE 5

With a new catheter, Example 1C was repeated but with 2000 ppm pyrogallol instead of 1000 ppm Vitamin C. The dry-out time was more than 25 min., as follows from Table 5.

TABLE 5

| Time (min) | Friction (gr) |
|---|---|
| 5 | 6.9 |
| 10 | 7.1 |
| 15 | 7.2 |
| 20 | 8.8 |
| 25 | 13.2 |

### EXAMPLE 6

With a new catheter, Example 1D was repeated but with glucose instead of PEG400. The dry-out time was at least 15 min. (friction was 12 gr after 15 min.)

### EXAMPLE 7

The following example shows an embodiment of the invention wherein stabilising compounds are included in the coating, as part of the coating procedure.

Catheters were produced using the same procedure and primer formulation as in example 1 and the top-coat formulations below. The topcoat I contained the stabilisers glycerol and 3,3″-ditert-butyl-4-hydroxy-benzylalcohol. Topcoat II contained no stabilisers.

TABLE 6
Composition Topcoat I and II

| | Top Coat I | Top Coat II |
|---|---|---|
| Component | wt. % | wt. % |
| PVP 1.3 M (K-90) | 5.5 | 5.5 |
| PAcA | 0.75 | 0.75 |
| Benzophenon | 0.12 | 0.12 |
| Distilled water | 46.5 | 46.8 |
| Methanol | 46.5 | 46.8 |
| Glycerol | 0.63 | — |
| 3,3″-ditert-butyl-4-hydroxy-benzylalcohol | 0.00625 | — |

The catheters were placed in an environment of which the air was saturated with water. After an uptake of water of approximately 70 mg per catheter, the catheters were sterilised using 25 kGy gamma irradiation. After sterilisation catheters were wetted for 1 minute in demineralised water.

Table 7 shows the lubricity (friction, in gr), 5, 10 or 15 min after taking the catheters out of the water, with or without sterilisation

TABLE 7

| exposure to | Topcoat I | Topcoat I | Topcoat II | Topcoat II |
|---|---|---|---|---|
| air (min) | unsterilised | sterilised | unsterilised | sterilised |
| 5 | 4.5 | 4.5 | 3.3 | >30 |
| 10 | 5.9 | 4.5 | 3.5 | |
| 15 | 6.2 | 5.5 | 4 | |

It is shown that lubricity is maintained after sterilisation in case a stabilising compound is used in accordance with the invention. If sterilisation is carried out in the absence of such compound, the friction is already too high within 5 min.

It is further interesting to note that in the unsterilised catheters the lubricity of the comparative coating (Topcoat 11) is better than that of the coating comprising glycerol and 3,3″-ditert-butyl-4-hydroxy-benzylalcohol. Thus, it is apparent that these compounds as such do not improve lubricity. This supports the inventors finding that these compounds play a role in avoiding the coating from reacting with radicals and/or other moieties formed from water as a result of the irradiation.

1. Use of at least one compound selected from the group consisting of aliphatic compounds, alicyclic compounds and antioxidants for protecting a wetted hydrophilic coating which is sterilised by irradiation—in particular with γ radiation or E-beam radiation—in the presence of water, from loss of lubricity and/or loss of dry-out time as a result of a reaction between the coating and a radical and/or another reactive moiety formed by irradiating the water.

2. Use according to claim 1, wherein the compound is a saturated aliphatic compound or a saturated alicyclic compound, preferably selected from saturated aliphatic alcohols, saturated aliphatic ethers, saturated aliphatic aldehydes, saturated aliphatic amides, saturated aliphatic esters, saturated aliphatic thiols, saturated aliphatic thioesters, saturated aliphatic organic acids and saturated aliphatic ketones.

3. Method for preparing a sterilised medical device comprising a hydrophilic coating, comprising
providing the device comprising the hydrophilic coating;
wetting the coating of the device with an aqueous wetting fluid; and
sterilising the wetted coated device by exposing it to an effective amount of radiation, in particular γ or E-beam radiation;
wherein the wetted coating and/or the wetting fluid comprise at least one aliphatic or alicyclic compound in a total concentration of at least 0.5 wt. %, preferably of 1.0-25 wt. %, more preferably of 2.5 to 20 wt. %, based upon the weight of the water.

4. Method for preparing a sterilised medical device, optionally according to claim 3, comprising a hydrophilic coating, comprising
providing the device comprising the hydrophilic coating;
wetting the coating of the device with an aqueous wetting fluid; and
sterilising the wetted coated device by exposing it to an effective amount of radiation, in particular γ or E-beam radiation;
wherein the wetted coating and/or the wetting fluid comprise at least one antioxidant in a total concentration of at least 0.005 wt. %, preferably of 0.01-1 wt. %, more preferably of 0.05 to 0.2 wt. %, based upon the weight of the water.

5. Method for preparing a sterilised medical device, optionally according to claim 3, comprising a hydrophilic coating, which method comprises
providing the device comprising the hydrophilic coating;
wetting the coating of the device with an aqueous wetting fluid;
sterilising the wetted coated device by exposing it to an effective amount of radiation, in particular γ or E-beam radiation;
wherein the wetted coating and/or the wetting fluid comprise at least one antioxidant and at least one compound selected from aliphatic and alicyclic compounds.

6. Method according to claim 3, wherein the aliphatic or alicyclic compound—if present—is selected from the group consisting of alcohols, ethers, aldehydes, amides, esters, thiols, thioesters, organic acids and ketones, preferably from saturated aliphatic alcohols, saturated aliphatic ethers, saturated aliphatic aldehydes, saturated aliphatic amides, saturated aliphatic esters, saturated aliphatic thiols, saturated aliphatic thioesters, saturated aliphatic organic acids and saturated aliphatic ketones, more preferably from glycerol, polyethylene glycol, isopropanol and combinations thereof.

7. Use or method according to claim 1, wherein the medical device is sterilised while being in a sealed packaging, together with the wetting fluid.

8. Medical device comprising a hydrophilic coating on a surface, wherein the coating comprises a hydrophilic polymer, water, and at least one aliphatic or alicyclic compound, wherein the total concentration of the aliphatic or alicyclic compound is at least 0.5 wt. %, preferably 1-25 wt. %, more preferably 2.5 to 20 wt. %, based upon the weight of the water.

9. Medical device, optionally according to claim 8, comprising a hydrophilic coating on an outer surface, wherein the coating comprises a hydrophilic polymer, water, and at least one antioxidant in a total concentration of at least 0.005 wt. %, preferably of 0.01-1 wt. %, more preferably of 0.05 to 0.2 wt. %, based upon the weight of the water.

10. Medical device, optionally according to claim 8, comprising a hydrophilic coating on an outer surface, wherein the coating comprises a hydrophilic polymer, at least one aliphatic or alicyclic compound, at least one antioxidant and water.

11. Medical device according to claim 8, wherein the aliphatic or alicyclic compound is selected from the group consisting of alcohols, ethers, aldehydes, amides, esters, thiols, thioesters, organic acids and ketones, preferably selected from saturated aliphatic alcohols, aliphatic ethers, saturated aliphatic aldehydes saturated aliphatic amides, saturated aliphatic esters, saturated aliphatic thiols, saturated aliphatic thioesters, saturated aliphatic organic acids and saturated aliphatic ketones, more preferably from glycerol, polyethylene glycol, isopropanol and combinations thereof.

12. Medical device comprising a hydrophilic coating on an outer surface, optionally according to claim 8, wherein the coating comprises a hydrophilic polymer, water and an aliphatic or alicyclic compound, wherein the aliphatic or alicyclic compound is selected from the group consisting of alcohols, ethers, aldehydes, amides, esters, thiols, thioesters, organic acids and ketones other than glycerol, diethylene glycol and sorbitol.

13. Medical device according to claim 8, wherein the antioxidant is a water soluble antioxidant, preferably selected from the group consisting of water-soluble phenolic antioxidants and water-soluble antioxidative vitamins, more preferably from vitamin C (ascorbic acid), alkyl hydroxybenzyl alcohols (such as 5-di-tert-butyl-4-hydroxybenzyl alcohol), alkyl hydroxybenzoic acids (such as 3,5-di-tert-butyl-4-hydroxybenzoic acid, 3,3″-ditert-butyl-4-hydroxy-benzylalcohol) pyrogallol, alkylated hydroxytoluene (such as butylated hydroxy toluene) and 2,6-ditertbutyl-4-ethyl-phenol.

14. Medical device according to claim 8, wherein the coating comprises a polymer selected from the group consisting of poly(lactams), in particular polyvinylpyrrolidones; polyurethanes; homo- and copolymers of acrylic and methacrylic acid; polyvinyl alcohols; polyvinylethers; maleic anhydride based copolymers; polyesters; vinylamines; polyethyleneimines; polyethyleneoxodes; poly(carboxylic acids); polyamides; polyanhydrides; polyphosphazenes; cellulosics, in particular methyl cellulose, carboxymethyl cellulose, hydroxymethylcellulose, hydroxypropylcellulose and other polysaccharides, in particular chitosans, hyaluronic acids, alginates, gelatins, chitins, heparins, dextrans; chondroitin sulphates; (poly)peptides/proteins, in particular collagens, fibrins, elastins, albumin; polyesters, in particular polylactides, polyglycolides, polycaprolactones; polynucleotides; and combinations of two or more of these polymers.

15. Medical device according to claim 8, wherein the coating comprises a polyelectrolyte, preferably a polyelectrolyte comprising at least one ionised or ionisable group selected from the group consisting of primary, secondary and tertiary amine groups, primary, secondary, tertiary and quaternary ammonium groups, phosphonium groups, sulphonium groups, carboxylic acid groups, carboxylate groups, sulphonic acid groups, sulphate groups, sulphinic acid groups, sulphinic groups, phosphinic groups and phosphate groups, more preferably a polyelectrolyte selected from the group consisting of (salts of) homopolymers and copolymers of acrylic acid, methacrylic acid, acrylamide, maleic acid, sulfonic acid, quaternary ammonium salts and mixtures and/or derivatives thereof.

16. Medical device according to claim 8, wherein the device is selected from the group consisting of catheters, medical tubing, guidewires, (needles of) syringes, nutritional delivery systems, canula's, thermometers, condoms, nasogastric tubes, endotracheal tubes and contact lenses.

17. Medical device according to claim 8, wherein the device is sterile.

18. An assembly comprising a wetted medical device according to claim 8, and an aqueous wetting fluid in a sealed packaging.

19. A coating composition for providing a medical device with a lubricious coating, comprising a hydrophilic polymer which is curable to provide a lubricious coating, a compound selected from the group consisting of aliphatic compounds, alicyclic compounds and antioxidants, and further optionally a polyelectrolyte, optionally a photoinitiator, and optionally a solvent.

20. A coating composition according to claim 19, comprising
at least one polymer selected from the group consisting of poly(lactams), in particular polyvinylpyrrolidones; polyurethanes; homo- and copolymers of acrylic and methacrylic acid; polyvinyl alcohols; polyvinylethers; maleic anhydride based copolymers; polyesters; vinylamines; polyethyleneimines; polyethyleneoxodes; poly(carboxylic acids); polyamides; polyanhydrides; polyphosphazenes; cellulosics, in particular methyl cellulose, carboxymethyl cellulose, hydroxymethylcellulose, hydroxypropylcellulose and other polysaccharides, in particular chitosans, hyaluronic acids, alginates, gelatins, chitins, heparins, dextrans; chondroitin sulphates; (poly)peptides/proteins, in particular collagens, fibrins, elastins, albumin; polyesters, in particular polylactides, polyglycolides, polycaprolactones; and polynucleotides;
at least one polyelectrolyte comprising at least one ionised or ionisable group selected from the group consisting of primary, secondary and tertiary amine groups, primary, secondary, tertiary and quaternary ammonium groups, phosphonium groups, sulphonium groups, carboxylic acid groups, carboxylate groups, sulphonic acid groups, sulphate groups, sulphinic acid groups, sulphinic groups, phosphinic groups and phosphate groups, preferably a polyelectrolyte selected from the group consisting of (salts of) homopolymers and copolymers of acrylic acid, methacrylic acid, acrylamide, maleic acid, sulfonic acid, quaternary ammonium salts and mixtures and/or derivatives thereof;
at least one aliphatic or alicyclic compound selected from the group consisting of alcohols, ethers, aldehydes, amides, esters, thiols, thioesters, organic acids and ketones, preferably from saturated aliphatic alcohols, ethers, aldehydes, amides, esters, thiols, thioesters, organic acids and ketones; and
at least one water soluble antioxidant, preferably selected from water-soluble phenolic antioxidants and water-soluble antioxidative vitamins.

21. A coating composition according to claim 20, comprising
at least one polyvinylpyrrolidone
at least one polyelectrolyte selected from the group consisting of (salts of) homopolymers and copolymers of acrylic acid, methacrylic acid, acrylamide, maleic acid, sulfonic acid, quaternary ammonium salts and mixtures and/or derivatives thereof;
at least one aliphatic or alicyclic compound selected from the group consisting of glycerol, polyethylene glycol, isopropanol, formic acid and a saccharide, in particular glucose; and
at least one water soluble antioxidant selected from vitamin C (ascorbic acid), alkyl hydroxybenzyl alcohols (such as 5-di-tert-butyl-4-hydroxybenzyl alcohol), alkyl hydroxybenzoic acids (such as 3,5-di-tert-butyl-4-hydroxybenzoic acid, 3,3″-ditert-butyl-4-hydroxy-benzylalcohol) pyrogallol, alkylated hydroxytoluene (such as butylated hydroxy toluene) and 2,6-ditertbutyl-4-ethyl-phenol.

22. Coating composition according to claim 19, wherein the hydrophilic polymer concentration is 1-90 wt. %, based on the dry weight of the composition, preferably 10-85 wt. %, more preferably 50-80 wt. %; the polyelectrolyte concentration is 1-90 wt. %, based on the dry weight of the composition, preferably 5-50 wt. %, more preferably 10-30 wt. %; the concentration of the antioxidant is at least 0.005 wt. % based on the dry weight of the composition, preferably 0.01-1 wt. %, more preferably 0.05-0.5 wt. %; and the aliphatic and/or alicyclic compound concentration is at least 0.5 wt. %, preferably 1.0-25 wt. %, more preferably 2.5-20 wt. %.

23. Method for manufacturing a device according to claim 8, comprising coating the device with a hydrophilic coating composition comprising at least one compound selected from the group consisting of the aliphatic compounds, alicyclic compounds and antioxidants.

24. Method according to claim 23, wherein the coating composition is a coating composition.
